(19) United States
(12) Patent Application Publication
(10) Pub. No.: US 2026/0147193 A1
(43) Pub. Date: May 28, 2026

(54) RELAY OPTICAL LENS ELEMENTS WITH AT LEAST ONE TIR SURFACE

(71) Applicant: Atieva, Inc., Newark, CA (US)

(72) Inventors: Hans-Christoph Eckstein, Woodside, CA (US); Wiebke Eckstein, Woodside, CA (US)

(21) Appl. No.: 18/957,164

(22) Filed: Nov. 22, 2024

(51) Int. Cl. G02B 13/00; G02B 1/04; G02B 1/11; G02B 27/01; G02B 27/30; G03B 21/14; G03B 21/20

(52) U.S. Cl. CPC G02B 13/0095; G02B 1/041; G02B 1/11; G02B 27/0101; G02B 27/30; G03B 21/145; G03B 21/2066

(57) ABSTRACT

A relay optical lens element comprises: a relay optical lens component made from a plastic material, the relay optical lens component comprising: a first convex lens formed of the plastic material, the first convex lens configured to act as an entrance pupil for the relay optical lens element; a first total internal reflection (TIR) surface formed at a first planar exterior surface of the relay optical lens component, the first TIR surface configured for light having entered through the first convex lens to undergo TIR inside the relay optical lens component at the first TIR surface; and a second convex lens formed of the plastic material, the second convex lens configured for the light having undergone the TIR at the first TIR surface to exit the relay optical lens element.

### TECHNICAL FIELD

This document relates to relay optical lens elements with at least one total internal reflection (TIR) surface.

### BACKGROUND

Various approaches have been tried to relay illumination between a light source and a microdisplay. One such approach involves having separate lenses and fold mirrors that translate the light from the angular homogeneity created by a microlens array (MLA) into homogeneity in space. A rear double TIR prism has been used in a way that suffers from significant loss of light. Namely, light may enter an assembly of three prisms cemented together, and once the light is reflected on the microdisplay the entire bundle comes under the TIR angle. However, the high incidence angles on glass surfaces cause Fresnel reflections and therefore loss of a substantial percentage of the light.

### SUMMARY

In a first aspect, a relay optical lens element comprises: a relay optical lens component made from a plastic material, the relay optical lens component comprising: a first convex lens formed of the plastic material, the first convex lens configured to act as an entrance pupil for the relay optical lens element; a first total internal reflection (TIR) surface formed at a first planar exterior surface of the relay optical lens component, the first TIR surface configured for light having entered through the first convex lens to undergo TIR inside the relay optical lens component at the first TIR surface; and a second convex lens formed of the plastic material, the second convex lens configured for the light having undergone the TIR at the first TIR surface to exit the relay optical lens element.

Implementations can include any or all of the following features. The plastic material comprises a thermoplastic material. The thermoplastic material comprises at least one of polycarbonate and polymethyl methacrylate. The plastic material comprises a thermosetting material. The first convex lens is a first aspherical convex lens. The second convex lens is a second aspherical convex lens. The relay optical lens component is configured for the light entering through the first convex lens to propagate directly from the first convex lens to the first TIR surface, and to propagate directly from the first TIR surface to the second convex lens. The relay optical lens component is configured for the light entering through the first convex lens to propagate directly from the first convex lens to the first TIR surface, the relay optical lens component further comprising: a second TIR surface formed at a second planar exterior surface of the relay optical lens component, the second TIR surface configured for the light having undergone TIR at the first TIR surface to also undergo TIR at the second TIR surface. The second planar exterior surface abuts the first planar exterior surface. The relay optical lens component further comprises: a third TIR surface formed at a third planar exterior surface of the relay optical lens component, the third TIR surface configured for the light having undergone TIR at the second TIR surface to also undergo TIR at the third TIR surface. The third planar exterior surface abuts the second planar exterior surface. The relay optical lens element is telecentric. The relay optical lens element further comprises a microprism on the first planar exterior surface. The microprism is formed of the plastic material. The microprism is a tetrahedron. The relay optical lens element further comprises a first antireflection coating on the first convex lens. The relay optical lens element further comprises a second antireflection coating on the second convex lens. The relay optical lens element further comprises a mounting feature for mounting the relay optical lens element, the mounting feature positioned on the relay optical lens component. The mounting feature is formed from the plastic material. The relay optical lens element further comprises a datum feature that is a reference for the relay optical lens element, the datum feature positioned on the relay optical lens component. The datum feature is formed from the plastic material.

In a second aspect, an optical projection system comprises: a light source; collimating optics configured to provide collimated light from the light source; a relay optical lens element configured to receive the collimated light, the relay optical lens element comprising: a relay optical lens component made from a plastic material, the relay optical lens component comprising: a first convex lens formed of the plastic material, the first convex lens configured to act as an entrance pupil for the relay optical lens element; a first total internal reflection (TIR) surface formed at a first planar exterior surface of the relay optical lens component, the first TIR surface configured for light having entered through the first convex lens to undergo TIR inside the relay optical lens component at the first TIR surface; and a second convex lens formed of the plastic material, the second convex lens configured for the light having undergone the TIR at the first TIR surface to exit the relay optical lens element; a microdisplay configured to receive light exiting the relay optical lens element; and a projection lens configured to receive light from the microdisplay.

Implementations can include any or all of the following features. The first convex lens is a first aspherical convex lens. The second convex lens is a second aspherical convex lens. The relay optical lens component is configured for the light entering through the first convex lens to propagate directly from the first convex lens to the first TIR surface, the relay optical lens component further comprising: a second TIR surface formed at a second planar exterior surface of the relay optical lens component, the second TIR surface configured for the light having undergone TIR at the first TIR surface to also undergo TIR at the second TIR surface. The second planar exterior surface abuts the first planar exterior surface. The relay optical lens component further comprises: a third TIR surface formed at a third planar exterior surface of the relay optical lens component, the third TIR surface configured for the light having undergone TIR at the second TIR surface to also undergo TIR at the third TIR surface. The third planar exterior surface abuts the second planar exterior surface. The relay optical lens element is telecentric. The light source includes multiple light-emitting diodes (LEDs), the optical projection system further comprises: a microprism on the first planar exterior surface, the microprism configured to extract light generated by the multiple LEDs; a photosensor configured generate an output based on the light extracted by the microprism; and a LED driver circuit configured to control the multiple LEDs using the output of the photosensor. The microprism is formed of the plastic material. The microprism is a tetrahedron. The optical projection system further comprises a first antireflection coating on the first convex lens. The optical projection system further comprises a second antireflection coating on the second convex lens. The optical projection system further comprises a mounting feature for mounting the relay optical lens element, the mounting feature positioned on the relay optical lens component. The mounting feature is formed from the plastic material. The optical projection system further comprises a datum feature that is a reference for the relay optical lens element, the datum feature positioned on the relay optical lens component. The datum feature is formed from the plastic material. The optical projection system further comprises a microlens array positioned between the collimating optics and the relay optical lens element. The microdisplay is a liquid crystal on silicon display. The microdisplay is a digital micromirror device. The microdisplay is a liquid crystal display. The optical projection system is included in a head-up display system for a vehicle.

In a third aspect, a vehicle headlight comprises: a light source; collimating optics configured to provide collimated light from the light source; a relay optical lens element configured to receive the collimated light, the relay optical lens element comprising: a relay optical lens component made from a plastic material, the relay optical lens component comprising: a first convex lens formed of the plastic material, the first convex lens configured to act as an entrance pupil for the relay optical lens element; a first total internal reflection (TIR) surface formed at a first planar exterior surface of the relay optical lens component, wherein the relay optical lens component is configured for the light entering through the first convex lens to propagate directly from the first convex lens to the first TIR surface, wherein the first TIR surface is configured for the light having entered through the first convex lens to undergo TIR inside the relay optical lens component at the first TIR surface; and a second convex lens formed of the plastic material, the second convex lens configured for the light having undergone the TIR at the first TIR surface to exit the relay optical lens element, wherein the relay optical lens component is configured for the light having undergone TIR at the first TIR surface to propagate directly from the first TIR surface to the second convex lens; a digital micromirror device configured to receive light exiting the relay optical lens element; and a projection lens configured to receive light from the digital micromirror device.

Implementations can include the following feature. The light source includes multiple light-emitting diodes.

### BRIEF DESCRIPTION OF DRAWINGS

FIG. 1 shows an example of a relay optical lens element.

FIG. 2 shows an example of an optical projection system including the relay optical lens element of FIG. 1.

FIGS. 3 and 4 show other examples of the optical projection system of FIG. 2.

FIG. 5 shows another example of the relay optical lens element of FIG. 1.

FIG. 6 schematically shows an example of a head-up display system for a vehicle.

FIG. 7 shows an example of an optical projection system.

FIG. 8 shows an example of a vehicle headlight.

Like reference symbols in the various drawings indicate like elements.

### DETAILED DESCRIPTION

This document describes examples of systems and techniques providing a relay optical lens element including at least one TIR surface for compact microdisplay illumination. A single relay optical lens element can replace the functionality of a pair of lenses and at least two mirrors while fitting inside a compact packaging space. The relay optical lens element can be a plastic component that uses TIR at the plastic-to-air interface of the element's surface without any coatings. The relay optical lens element also advantageously allows light extraction for a sensor. Such a relay optical lens element can be used in any of a variety of implementations where compact illumination is beneficial, including, but not limited to, in a picture generating unit (PGU) of a head-up display (HUD) of a vehicle, in another projection system (e.g., for home entertainment), in a vehicle headlight, in a projector of a mobile device, or in wearable smart technology (e.g., glasses).

In some implementations, a relay optical lens element can be used for illumination of a microdisplay, such as a liquid crystal on silicon (LCOS), a digital micromirror device (DMD), or a liquid-crystal display (LCD). The relay optical lens element can consist of a plastic component defining two lenses and one or more TIR surfaces. A first convex lens surface (e.g., an aspherical surface) can act as an entrance pupil and receive an angular light distribution of the illumination. For example, this can be provided by using collimated light-emitting diodes (LEDs) with an MLA homogenizer. The light distribution can have a spread lower than about ten degrees with different respective spreads in the x-and y-directions due to the size of the microdisplay being used. After refraction at the first lens surface the light propagates to at least one (e.g., two or three) surfaces of the plastic component based on TIR due to the plastic-air interface. This creates the designed three-dimensional (3D) orientation of the light and ultimately produces the image. The exit surface of the relay optical lens element is a convex lens surface (e.g., an aspherical surface). An image of the angular distribution can be generated on the microdisplay surface (e.g., LCOS, DMD, or LCD) which allows homogeneous illumination by focusing the light with proper definition by the first and last lens surfaces of the optical element. The total track length can be significantly shorter than the effective focal length of the system to allow a compact design. The geometry of the plastic component can be tailored

Implementations of the present subject matter can provide advantages including, but not limited to, the following. Homogeneous illumination of a microdisplay can be provided within a small package space. A single plastic component can provide the functionality of two lenses and at least two mirrors. A compact illumination design can be provided that has a reduced total track length for the light. Using an injection molded part for the relay optical lens element can be a cost effective solution. The use of TIR requires no coating on the element and has great efficiency because there is no absorption. Using a relay optical lens element of a single plastic component can improve assembly tolerances. The plastic element can be designed to incorporate mounting elements and/or datum features to simplify installation. A microprism can be integrated in the design of the relay optical lens element to extract light for a photosensor. The microprism can be positioned where collimated homogeneous light is available without the light extraction affecting the homogeneity or efficiency of the illumination.

Examples described herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger compartment accommodating one or more persons. A person traveling with the vehicle can be characterized as a driver and/or an occupant. For simplicity, the user of the systems described herein will be referred to as an occupant, regardless of whether the person performs any driving tasks with regard to the vehicle.

Examples described herein refer to a microdisplay. As used herein, a microdisplay is a device configured for use in projecting light for one or more purposes. The microdisplay can include, but is not limited to, at least one of an LCOS, a DMD or an LCD. The microdisplay can operate based on reflection and/or transmission of light.

Examples described herein refer to a front, rear, top, or a bottom. These and similar expressions identify things or aspects in a relative way based on an express or arbitrary notion of perspective. That is, these terms are illustrative only, used for purposes of explanation, and do not necessarily indicate the only possible position, direction, and so on.

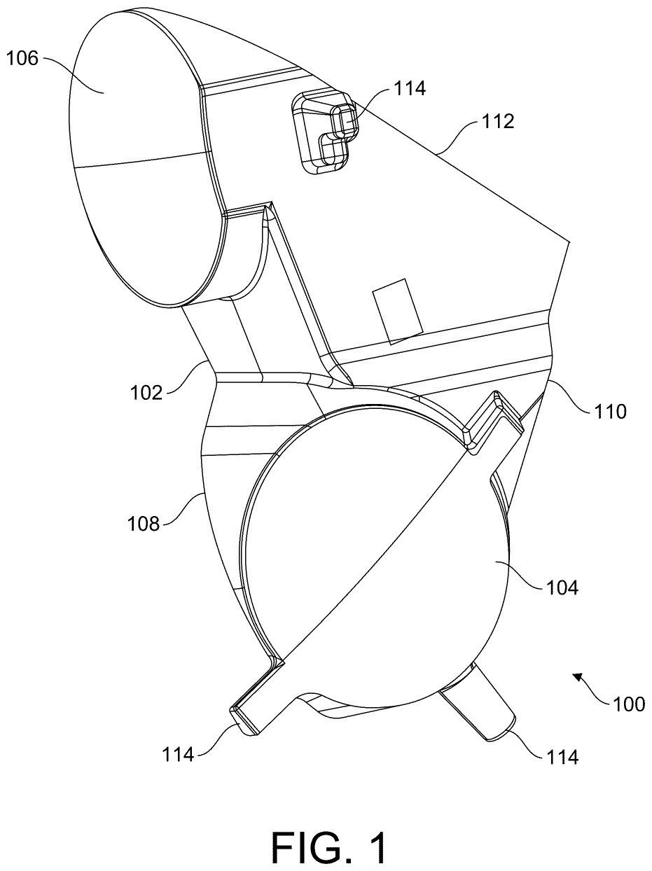

FIG. 1 shows an example of a relay optical lens element 100. The relay optical lens element 100 can be used with one or more other examples described elsewhere herein. In an implementation, such as in a projection system, the relay optical lens element 100 can serve as a relay of illumination light that bends (folds) the light and also focuses the light beam and gives it the correct size and direction for its intended purpose, for example as described below.

The relay optical lens element 100 can include (e.g., can consist of) a relay optical lens component 102 which can be a single component made from a plastic material. In some implementations, the relay optical lens component 102 is made from a thermoplastic material that has sufficient optical properties (e.g., of transparency). For example, a polycarbonate material and/or a polymethyl methacrylate material can be used. In some implementations, the relay optical lens component 102 is made from a thermosetting material that has sufficient optical properties. The relay optical lens element 100 can be manufactured using a molding process. For example, injection molding can be used.

The relay optical lens element 100 includes a convex lens 104 formed of the plastic material. The convex lens 104 is configured to act as an entrance pupil for the relay optical lens element 100. In some implementations, the convex lens 104 is an aspherical surface or another free form surface. For example, the convex lens 104 can be an aspherical convex lens. The convex lens 104 can be designed to minimize the amount of stray light rays in the illumination path to avoid unnecessary heat generation. The relay optical lens element 100 includes a convex lens 106 formed of the plastic material. The convex lens 106 is configured to act as an exit for the light passing through the relay optical lens element 100. In some implementations, the convex lens 106 is an aspherical surface or another free form surface. For example, the convex lens 106 can be an aspherical convex lens.

The relay optical lens element 100 can be designed to support TIR of the illumination light at one or more surfaces. The relay optical lens element 100 can define one or more planar exterior surfaces that provide TIR of the light. A plastic-air interface is formed at the planar exterior surface, in that the plastic has a higher refractive index than the surrounding medium (e.g., air). As a result, illumination light impinging on the plastic-air interface with at least the critical angle to the surface normal will undergo TIR. More specifically, the light being transmitted can be a bundle of rays having somewhat different incident angles. As such, one constraint on the geometric design can be that all incident angles of the rays in the bundle should be kept greater than the critical angle so they do not couple out. As a result, the light will be reflected inside the relay optical lens element 100 at the plastic-air interface and not be transmitted to the outside of the relay optical lens element 100.

Here, the relay optical lens element 100 has TIR surfaces 108, 110 and 112. Each of the TIR surfaces 108, 110 and 112 is defined by a planar exterior surface of the relay optical lens element 100. The relay optical lens element 100 is designed so that the light impinges on each of the TIR surfaces 108, 110 and 112 with an incident angle that is at least equal to the critical angle. As a result, the light can undergo TIR inside the relay optical lens component 102 at each of the TIR surfaces 108, 110 and 112. For example, light can enter at the convex lens 104, propagate directly to the TIR surface 108 and undergo TIR there, then propagate directly to the TIR surface 110 and undergo TIR there, then propagate directly to the TIR surface 112 and undergo TIR there, and finally exit the relay optical lens element 100 at the convex lens 106. In the current illustration, only some edges of the TIR surfaces 108, 110 and 112 are visible, but examples of the TIR surfaces 108, 110 and 112 are shown in other figures herein.

The relay optical lens element 100 can include one or more features 114 formed in the relay optical lens component 102. The feature 114 can be formed from the plastic material and can be integral to the design of the relay optical lens component 102. For example, the feature 114 is formed as part of the injection molding process. In some implementations, the feature 114 includes a mounting feature for mounting the relay optical lens element 100. For example, the mounting feature can be used for installing the relay optical lens element 100 within a PGU of a HUD in a vehicle. In some implementations, the feature 114 includes a datum feature that is a reference for the relay optical lens element 100. For example, the datum feature helps indicate the x-, y- and z-position of the relay optical lens element 100 in an installation.

The relay optical lens element 100 can be telecentric. This can be accomplished by the design of the convex lenses 104 and 106. For example, by way of its telecentricity, the relay optical lens element 100 can maximize imaging performance, lower distortion and ensure accurate illumination for the projection.

The relay optical lens element 100 can be used with or without external coating. The relay optical lens component 102 that can be formed by injection molding can provide the required TIR without any additional coating being applied to the plastic material. As a convenient expression, the relay optical lens component 102 can be referred to as a Bi-Lens Optical Block, or BLOB for short.

The above examples illustrate that a relay optical lens element (e.g., the relay optical lens element 100) can include: a relay optical lens component (e.g., the relay optical lens component 102) made from a plastic material, the relay optical lens component comprising: a first convex lens (e.g., the convex lens 104) formed of the plastic material, the first convex lens configured to act as an entrance pupil for the relay optical lens element; a first TIR surface (e.g., the TIR surface 108) formed at a first planar exterior surface of the relay optical lens component, the first TIR surface configured for light having entered through the first convex lens to undergo TIR inside the relay optical lens component at the first TIR surface; and a second convex lens (e.g., the convex lens 106) formed of the plastic material, the second convex lens configured for the light having undergone the TIR at the first TIR surface to exit the relay optical lens element.

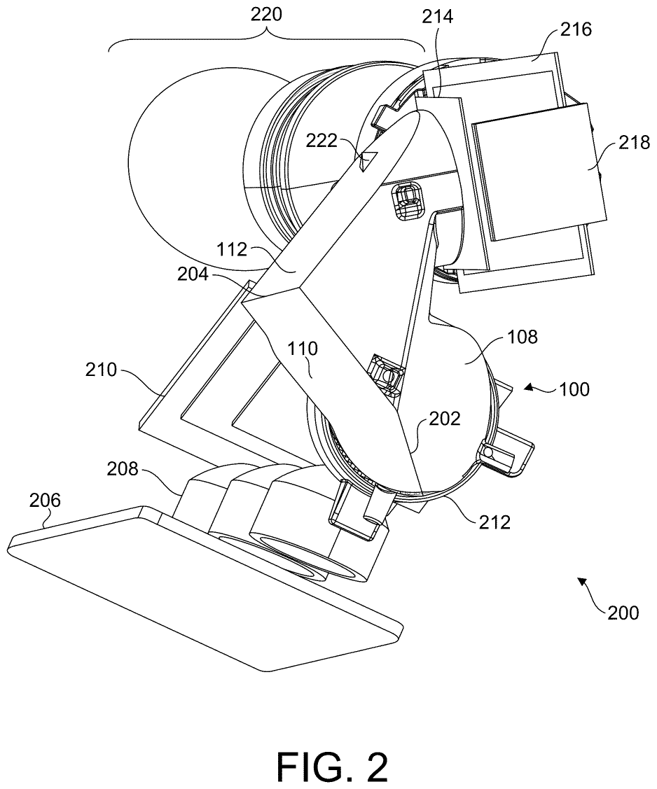

FIG. 2 shows an example of an optical projection system 200 including the relay optical lens element 100 of FIG. 1. The optical projection system 200 can be used with one or more other examples described elsewhere herein.

In some implementations, the optical projection system 200 can use the relay optical lens element 100 to illuminate a microdisplay such as an LCOS, for example within a PGU of a HUD in a vehicle. When redesigning a HUD or any other system using the optical projection system 200 to have a different orientation of the microdisplay than before, the relay optical lens element 100 can be an efficient way of arranging the illumination path accordingly.

In this illustration the relay optical lens element 100 shows an example of how the TIR surfaces 108, 110 and 112 can be shaped and positioned. In some implementations, the TIR surface 110 abuts the TIR surface 108. For example, the TIR surface 110 can abut the TIR surface 108 along an edge 202 of the relay optical lens element 100. In some implementations, the TIR surface 112 abuts the TIR surface 110. For example, the TIR surface 112 can abut the TIR surface 110 along an edge 204 of the relay optical lens element 100.

The optical projection system 200 includes a circuit board 206 that can control and supply power to at least one light source for the illumination. In some implementations, the circuit board 206 can include one or more light sources, for example LEDs. For example, the circuit board 206 can be a printed circuit board having one or more types of LEDs for generating red, green or blue light. The light source of the circuit board 206 can be positioned at the object plane of the optical projection system 200.

The optical projection system 200 includes one or more instances of collimating optics 208. For example, the collimating optics 208 can include one or more lenses for each light source of the circuit board 206. The optical projection system 200 includes one or more instances of reflectors 210 to fold the illumination light and orient light from multiple light sources into a common direction. Each of the collimating optics 208 can be provided with a corresponding one of the reflectors 210. For example, one or more of the reflectors 210 includes a dichroic mirror.

The optical projection system 200 includes an MLA 212 that can pre-shape the intensity distribution of the light from the light source(s). The MLA 212 can include an array (e.g., of one or two dimensions) of microlenses (e.g., lenslets) through which light passes and becomes homogenized in angular space. In some implementations, a double-sided MLA is used.

The optical projection system 200 here includes the relay optical lens element 100. The MLA output can include a light cone with angular spread, and the geometry of the relay optical lens element 100 can be designed so that TIR occurs at the planar exterior surfaces, the light is given the correct orientation, and the optical projection system 200 has the proper track length. As such, the optical projection system 200 does not need, and can omit, any additional lenses having particular modulation transfer functions, or camera lenses, to name two examples.

The output of the MLA 212, being light having a distribution of purely angles, can be directed toward the entrance pupil of the relay optical lens element 100. Inside the relay optical lens element 100, the light can undergo TIR at one or more TIR surfaces. For example, TIR can occur at the TIR surfaces 108, 110 and 112 in that order. Because of the TIR, the relay optical lens element 100 can allow the optical projection system 200 to fit within more compact packaging. For example, an illumination lens that would otherwise extend in a direction that causes the packaging volume to be increased, can instead be oriented to extend along a plane that is occupied by the projection lens.

The optical projection system 200 can include an optical component 214. In some implementations, the optical component 214 is a polarizer. The optical projection system 200 can include an optical component 216. In some implementations, the optical component 216 is a beam splitter. For example, the optical component 216 can include a dichroic mirror.

The optical projection system 200 includes a microdisplay 218 configured to receive light exiting the relay optical lens element 100. The microdisplay 218 can serve as the image plane for the projection performed by the optical projection system 200. For example, the microdisplay 218 includes an LCOS, DMD or LCD. The microdisplay 218 can modify the illumination light in one or more ways before projection. In a HUD system implementation, the microdisplay can modulate the light spatially to form image contents that are to be presented to the occupant via the HUD.

The optical projection system 200 includes a projection lens assembly 220 of one or more projection lenses and/or other optical components. The projection lens assembly 220 conditions the light from the microdisplay before projection. After the projection lens assembly 220, the light can arrive at one or more additional optical elements before being visible to a user.

The relay optical lens element 100 can include a microprism 222 positioned at one of the TIR surfaces 108, 110 and 112 to perform light extraction. That is, the microprism 222 can be placed at one of the planar exterior surfaces of the relay optical lens component 102 where the light undergoes TIR so some of the light does escape to the outside (i.e., does not undergo TIR at the location of the microprism 222). The microprism 222 can be placed where white light is available. Locations of the TIR surface that can be avoided for the placement of the microprism 222 include, but are not limited to, the center of the TIR surface to avoid unnecessary loss of light; and also the peripheral edges of the light distribution, so the microprism 222 does not run out of light if there is a small variation in the position of the light source. The microprism 222 can be formed from the plastic material and can be integral to the design of the relay optical lens component 102. For example, the microprism 222 is formed as part of the injection molding process. In some implementations, the microprism 222 is a tetrahedron. A base of the tetrahedron coincides with the planar exterior surface. At one or more of the remaining faces of the tetrahedron, the light has an incident angle less than the critical angle so TIR does not occur at one or more of the remaining faces and that light escapes. The extracted light can be used for one or more purposes, for example as will be described below.

Having the relay optical lens element 100 in the optical projection system 200 can facilitate making the optical track length shorter, because light is traveling in the plastic material of the relay optical lens component 102. In some implementations, the total track length can be less than about half of the focal length. That is, keeping the light inside the plastic material of the relay optical lens element 100 while undergoing (in this example) three TIRs can make the track length shorter. Having a smaller number of TIRs (e.g., fewer than three) can provide relatively less design freedom in positioning the microdisplay, but with three TIRs as in this example, the microdisplay can be placed in any direction. As also mentioned elsewhere herein, the relay optical lens element 100 can be made telecentric. In a HUD system, the lenses of the projection lens assembly 220 will be projecting the image of the microdisplay 218 onto an eyebox associated with a vehicle occupant, and the relay optical lens element 100 needs to be telecentric to also see the image in a homogeneous way from the eyebox in any direction.

That is, using the relay optical lens element 100 can provide a packing advantage in terms of allowing the system to be made more compact, but can also reduce total track length. In designing the optical system, it may be necessary to simultaneously meet multiple conditions: the focal point needs to be on the microdisplay, a specific focal length is needed to obtain the right size of the image, and the illumination needs to be telecentric so the incident angles are correct. For this, a specific optical pathlength is needed from entrance to exit, and then those two optical axes should be pointing in the same direction but in opposite orientations. Moreover, these optical components should be positioned next to each other in a way that nothing sticks out of the volume so as to not unnecessarily complicate the packaging design.

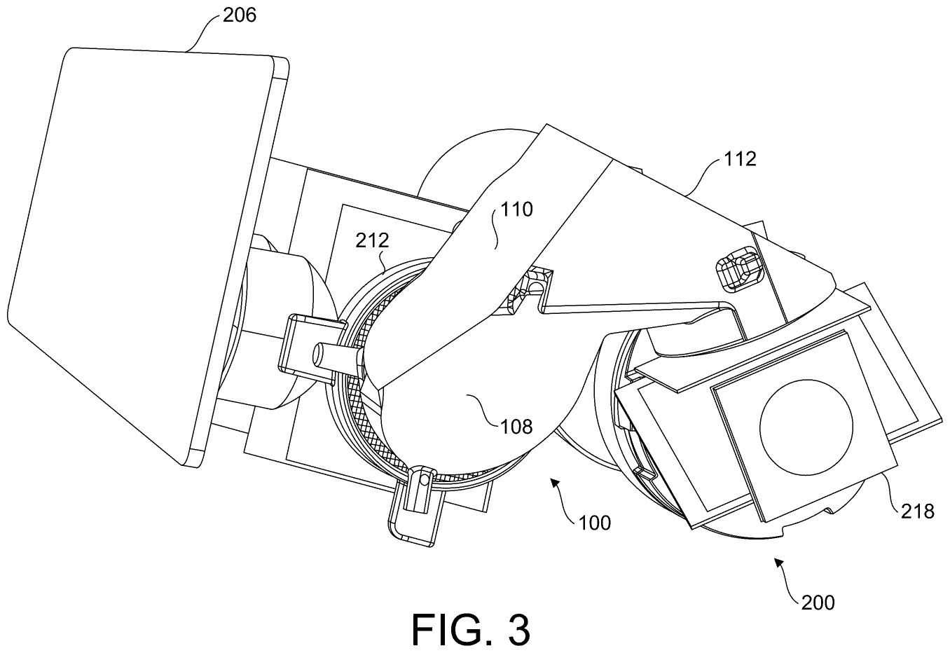

FIGS. 3 and 4 show other examples of the optical projection system 200 of FIG. 2. LEDs 400, 402 and 404 are mounted on the circuit board 206. The LEDs 400, 402 and 404 can have different optical properties. For example, the LEDs 400, 402 and 404 can generate red, green and blue light, respectively. Each of the LEDs 400, 402 and 404 can have a corresponding one of the collimating optics 208. The LED 400 has a reflector 210A, the LED 402 has a reflector 210B, and the LED 404 has a reflector 210C. The reflectors 210A-210C can all have identical optical characteristics, or at least one of the reflectors 210A-210C can have some different characteristic(s).

In operation, light from the LEDs 400, 402 and 404, can be collimated by the collimating optics 208; reflected by the reflectors 210A-210C toward the MLA 212; homogenized by the MLA 212; enter the relay optical lens element 100 through the convex lens 104; undergo TIR at the TIR surfaces 108, 110 and 112 in that order; exit the relay optical lens element 100 through the convex lens 106; be modulated by the optical components 214 and 216; and impinge on the microdisplay 218. Light from the microdisplay 218 can be projected by the projection lens assembly 220.

The above examples illustrate that an optical projection system (e.g., the optical projection system 200) can include: a light source (e.g., the LEDs 400, 402 and 404); collimating optics (e.g., the collimating optics 208) configured to provide collimated light from the light source; a relay optical lens element (e.g., the relay optical lens element 100) configured to receive the collimated light, the relay optical lens element comprising: a relay optical lens component (e.g., the relay optical lens component 102) made from a plastic material, the relay optical lens component comprising: a first convex lens (e.g., the convex lens 104) formed of the plastic material, the first convex lens configured to act as an entrance pupil for the relay optical lens element; a first TIR surface (e.g., the TIR surface 108) formed at a first planar exterior surface of the relay optical lens component, the first TIR surface configured for light having entered through the first convex lens to undergo TIR inside the relay optical lens component at the first TIR surface; and a second convex lens (e.g., the convex lens 106) formed of the plastic material, the second convex lens configured for the light having undergone the TIR at the first TIR surface to exit the relay optical lens element; the optical projection system further includes a microdisplay (e.g., the microdisplay 218) configured to receive light exiting the relay optical lens element; and a projection lens (e.g., the projection lens assembly 220) configured to receive light from the microdisplay.

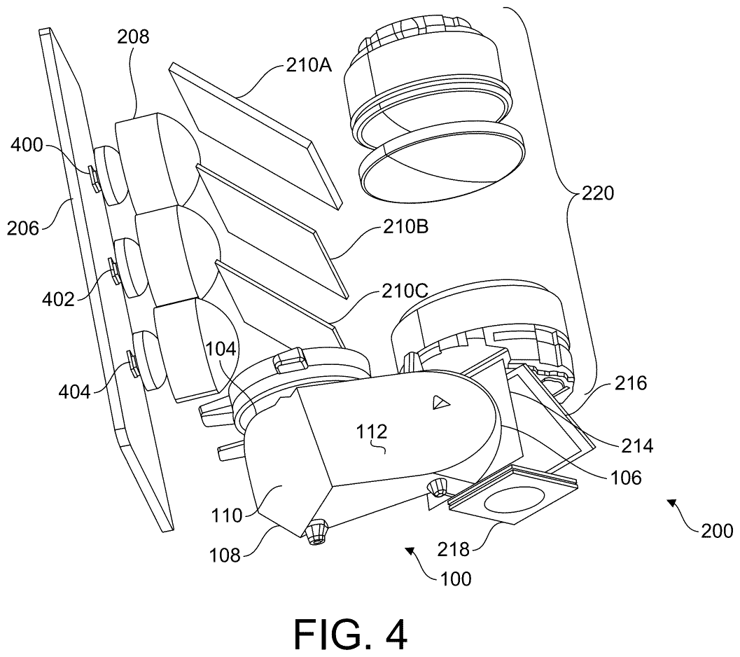

FIG. 5 shows another example of the relay optical lens element 100 of FIG. 1. It was mentioned above that the relay optical lens element 100 can be an injection molded single piece of plastic that can be used in an optical projection system without any coatings. Here, however, an example will be described of using coatings.

In this illustration, an enlargement 500 shows a partial section view of the convex lens 104 where a plastic material 502 of the relay optical lens element 100 defines a convex lens surface 504. An antireflection coating 506 can be applied on the convex lens surface 504. That is, the convex lens surface 504 coated by the antireflection coating 506 is not in contact with air 508. For example, the antireflection coating 506 can prevent illumination light (e.g., arriving from an MLA) from being reflected by the convex lens surface 504 and instead facilitate that the light enters the relay optical lens element 100.

An enlargement 510 shows a partial section view of the convex lens 106 where the plastic material 502 of the relay optical lens element 100 defines a convex lens surface 512. An antireflection coating 514 can be applied on the convex lens surface 512 defined by the plastic material 502. That is, the convex lens surface 512 coated by the antireflection coating 514 is not in contact with the air 508. For example, the antireflection coating 514 can prevent the illumination light inside the relay optical lens element 100 from being reflected by the convex lens surface 512 back into the relay optical lens element 100.

The antireflection coatings 506 and 514 can be the same materials as each other or different materials. An antireflection coating can include one or more layers of transparent material. For example, a single dielectric layer or a dielectric layer stack can be used.

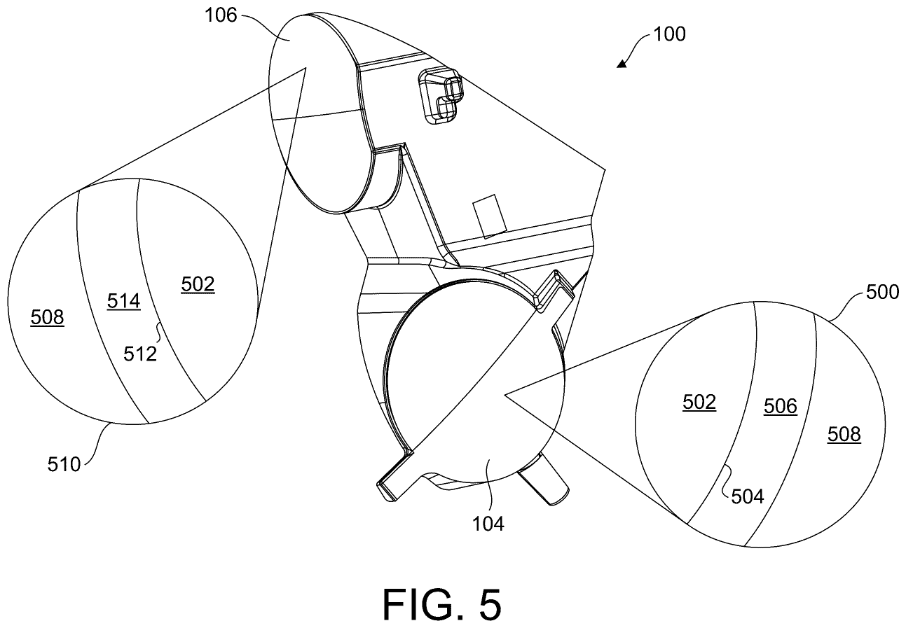

FIG. 6 schematically shows an example of a HUD system 600 for a vehicle. The HUD system 600 can be used with one or more other examples described elsewhere herein. The HUD system 600 is schematically shown, and some components are omitted, or shown schematically, for simplicity. The HUD system 600 can be configured for installation in a vehicle, most of which is also omitted in the respective illustrations. Some features of the HUD system 600 will be described with reference to a Cartesian coordinate system, approximately oriented in the drawing. The coordinate system indicates an x-direction (e.g., a forward direction along which the vehicle can travel), a y-direction (e.g., a direction across the vehicle from side to side, pointing out of the plane of the drawing), and a z-direction (e.g., a vertical direction upward with regard to the vehicle).

The HUD system 600 includes a PGU 602 that provides illumination and image content. For example, the PGU 602 can include the optical projection system 200 (FIGS. 2-4) or parts thereof. The PGU 602 has a light source based on one or more illumination techniques. In some implementations, the PGU 602 provides illumination using one or more LEDs. For example, LEDs of multiple colors (e.g., red, green, blue) can be provided. In some implementations, the PGU 602 can generate an image using an LCOS, DMD, LCD or any other microdisplay. For example, the PGU 602 can use one or more optical elements, including but not limited to, the relay optical lens element 100 (e.g., FIG. 1) between the light source and the microdisplay, and/or elsewhere.

The HUD system 600 includes a hybrid reflective intermediate image screen 604 that can be flat or curved. The structure of the hybrid reflective intermediate image screen 604 can be characterized by at least a field correction term and a diffuser term. The shape of the hybrid reflective intermediate image screen 604 can be decomposed in a specific curvature of the mirror and a specific computed diffuser height profile (e.g., with structure sizes in the micrometer range for visible light) which delivers a certain scattering distribution. The curvature can be described with a lens function, for example a two-dimensional freeform (e.g., described by a polynomial function) or it can be a biconic shape or a cylindrical shape. The curvature and the computed diffusor height profile can be designed so that the light path of all field points of the image projected on the hybrid reflective intermediate image screen 604 coming from the PGU 602 match the required illumination in an eye box 606 (the area where the driver/occupant's eyes should be located for observation of the virtual image). The hybrid reflective intermediate image screen 604 can receive light from the PGU 602.

The HUD system 600 can include a mirror 608. The existence and position of the mirror 608 depends strongly on the optical specifications and the given package volume. In the shown HUD system 600, the mirror 608 is a plane/flat folding mirror to tailor the beam path within its given package volume and reduce the overall necessary volume of the windshield HUD system 600. The mirror 608 may have no optical power and can serve to fit the package. The mirror 608 can receive light scattered from the hybrid reflective intermediate image screen 604 having a lens function. The mirror 608 can include any substrate having reflective properties that allow sufficient light originating at the PGU 602 to be reflected. For some applications, the mirror 608 can be characterized as a freeform mirror. For example, the mirror 608 can have a lens function (e.g., biconical, spherical, aspherical or freeform, e.g., based on a polynomial description (e.g., a Chebyshev polynomial)). For example, a freeform surface can be described by a base radius of curvature and a sequence of Chebyshev polynomials. The mirror 608 can contain coatings to improve efficiency, color, stray-light/sun-light suppression or contrast. For example, the mirror 608 can have a cold mirror coating allowing only rays under a certain wavelength threshold to get reflected. Longer wavelength, e.g., infrared light from the sun will be transmitted and can be placed on an absorber. Further, coatings improving the reflectivity can be used. Further, a polarization film (e.g., a waveplate or polarizer) can be placed on the mirror to improve contrast or suppress stray light (e.g., sun light).

The HUD system 600 includes a freeform mirror 610 that can either receive light reflected from the mirror 608 or directly receive scattered light from the hybrid reflective intermediate image screen 604, in case mirror 608 is not existent. The freeform mirror 610 can include any substrate having reflective properties that allow sufficient light originating at the PGU 602 to be reflected. The freeform mirror 610 acts as magnifier and compensates the shape of the windshield; as such, the freeform mirror 610 can have a lens function (e.g., biconical, spherical, aspherical or freeform, such as based on a 2D polynomial). For example, a freeform surface can be described by a base radius of curvature and a sequence of Chebyshev polynomials. The mirror 608 and/or the freeform mirror 610 can contain one or more of the same or different coatings to improve efficiency, color, stray-light/sun-light suppression or contrast. For example, if the HUD system 600 includes the mirror 608, the coating(s) can preferably be placed on the mirror 608.

The HUD system 600 includes a cover 612 used as a glare trap. The cover 612 can be positioned between the freeform mirror 610 and a windshield 614 of the vehicle. The cover 612 can contain one or more coatings to improve efficiency, color, stray-light/sun-light suppression and/or contrast.

The HUD system 600 can project light that when reflected by the windshield 614 and then observed by the occupant at the eye box 606 creates the appearance of a virtual image 616 for the occupant. The virtual image 616 can be characterized as being located at a virtual image distance from the eye box 606.

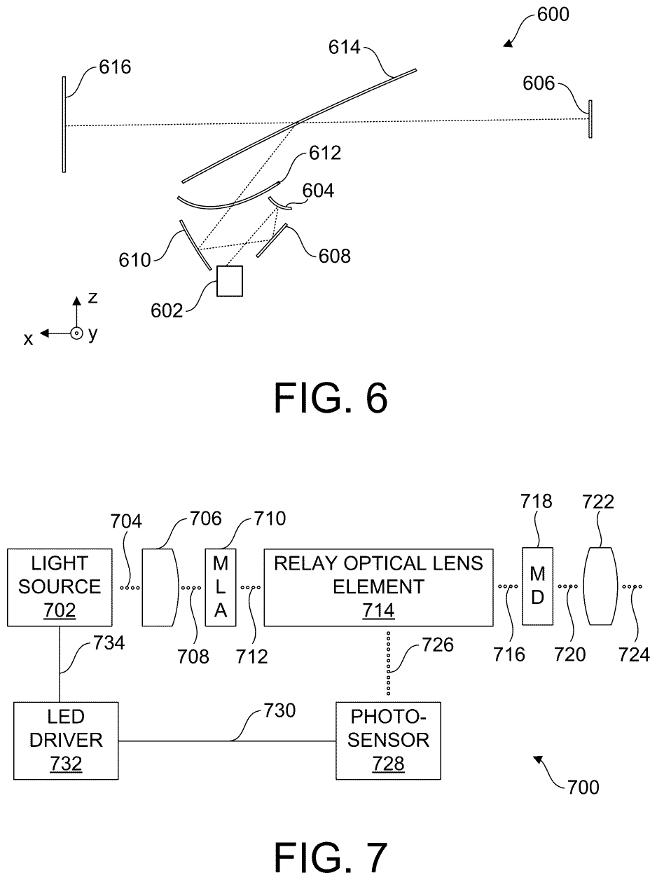

FIG. 7 shows an example of an optical projection system 700. The optical projection system 700 can be used with one or more other examples described elsewhere herein. The optical projection system 700 is schematically illustrated as a box diagram.

The optical projection system 700 includes a light source 702. Any of various kinds of light sources can be used. In some implementations, the light source 702 includes one or more LEDs (e, g., the LEDs 400, 402 and 404 of FIG. 4). The light source 702 outputs light 704.

The light 704 can be collimated by one or more collimating optics 706. For example, the one or more collimating optics 706 includes one or more lenses or other optical elements. Collimated light 708 can emerge from the collimating optics 706.

The collimated light 708 can enter an MLA 710 to homogenize the collimated light 708. For example, the MLA 710 includes an array of lenslets. Light 712 can emerge from the MLA 710.

The optical projection system 700 includes a relay optical lens element 714. The relay optical lens element 714 is made of a plastic material and includes at least two convex lenses and at least one TIR surface. For example, the relay optical lens element 100 (e.g., FIG. 1) can be used. Light 716 can exit the relay optical lens element 714 through one of the convex lenses.

The light 716 can impinge on a microdisplay 718 that can introduce image information or other spatial modulation. Light 720 emerges from the microdisplay 718. For example, when the optical projection system 700 is a HUD system the light 720 can include HUD content that is to be presented on a windshield and be viewed by an occupant.

The light 720 can be projected using a projection lens assembly 722 that can include one or more lenses. For example, when the optical projection system 700 is a HUD system the projection lens assembly 722 can project light 724 onto a windshield of the vehicle to make a virtual image visible to an occupant.

The optical projection system 700 can have one or more types of feedback control. In some implementations, illumination light 726 exits the relay optical lens element 714, such as by way of a microprism configured for light extraction (e.g., the microprism 222 of FIG. 2). The light 726 is provided to a photosensor 728 (e.g., including at least one photodiode). The photosensor 728 generates an output 730 based on the light 726 that can be used for one or more purposes. The output 730 can be used for controlling the light source 702. In some implementations, the light source 702 includes one or more LEDs that can be controlled by a LED driver circuit 732. When the LEDs generate multiple colors, the light 726 extracted from the relay optical lens element 714 can be a good representation of the characteristics of the illumination light in that it contains all colors united. The photosensor 728 can help measure the LED color point to determine the white point of the illumination light. The white point of a given LED light source can change with temperature and aging. For example, a red LED can derate differently than blue or green LEDs, so to keep the illumination light white for different temperatures the white point must be measured. Accordingly, the LED driver circuit 732 can control, by way of a signal 734, the LEDs of the light source 702 using the output 730 of the photosensor 728.

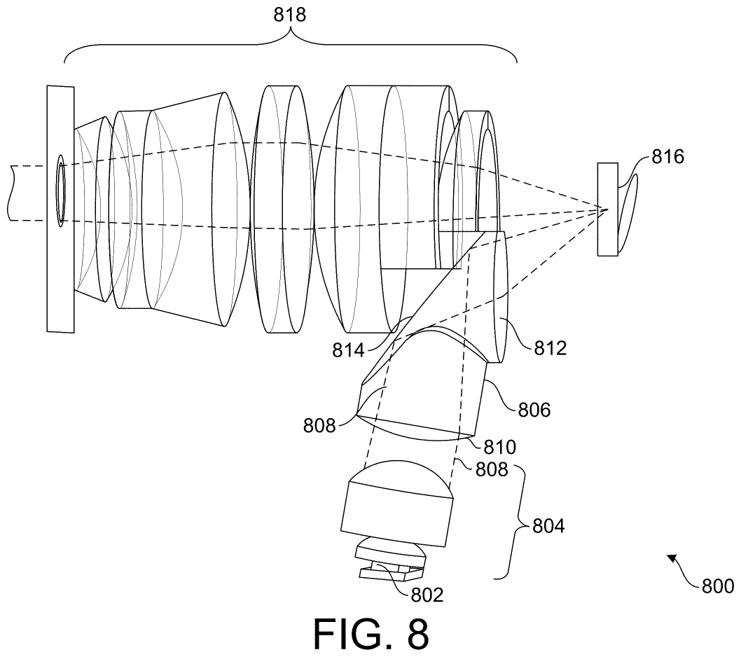

FIG. 8 shows an example of a vehicle headlight 800. The vehicle headlight 800 can be used with one or more other examples described elsewhere herein. The vehicle headlight 800 includes a light source 802. For example, one or more LEDs can be used (e.g., on a board such as a printed circuit board). The vehicle headlight 800 includes collimating optics 804. For example, one or more lenses can be included. The vehicle headlight 800 includes a relay optical lens element 806 configured to receive collimated light 808. The relay optical lens element 806 is made of a plastic material and includes at least convex lenses 810 and 812 and a TIR surface 814. That is, the geometry of the relay optical lens element 806 is designed so that all rays of the collimated light 808 (e.g., a bundle of light) have incident angles at the TIR surface 814 that cause TIR. The relay optical lens element 806 can be made by a molding process (e.g., injection molding) and may or may not have coatings. The TIR surface 814 is formed at a planar exterior surface of the relay optical lens element 806. Here, the light 808 enters the relay optical lens element 806 through the convex lens 810, propagates directly to the TIR surface 814 and undergoes TIR there, and thereafter propagates directly to the convex lens 812 and exits the relay optical lens element 806 there. The vehicle headlight 800 includes a DMD 816 configured to receive the collimated light 808 exiting the relay optical lens element 806. The vehicle headlight 800 includes a projection lens assembly 818 configured to receive light from the DMD 816. For example, the projection lens assembly 818 includes one or more projection lenses. The vehicle headlight 800 may omit having an MLA and as such can essentially generate an image of the LED chip of the light source 802, which may be acceptable for a vehicle headlight as the primary goal may be to get as much light as possible, not homogeneity in the light. To make the packaging of the vehicle headlight 800 more compact, the design can be modified to fold the collimated light 808 in one or more ways. For example, the relay optical lens element 806 can be modified to have more TIR surfaces than just the TIR surface 814.

The above examples illustrates that a vehicle headlight (e.g., the vehicle headlight 800) can include: a light source (e.g., the light source 802); collimating optics (e.g., the collimating optics 804) configured to provide collimated light from the light source; a relay optical lens element (e.g., the relay optical lens element 806) configured to receive the collimated light, the relay optical lens element comprising: a relay optical lens component made from a plastic material, the relay optical lens component comprising: a first convex lens (e.g., the convex lens 810) formed of the plastic material, the first convex lens configured to act as an entrance pupil for the relay optical lens element; a first TIR surface (e.g., the TIR surface 814) formed at a first planar exterior surface of the relay optical lens component, wherein the relay optical lens component is configured for the light entering through the first convex lens to propagate directly from the first convex lens to the first TIR surface, wherein the first TIR surface is configured for the light having entered through the first convex lens to undergo TIR inside the relay optical lens component at the first TIR surface; and a second convex lens (e.g., the convex lens 812) formed of the plastic material, the second convex lens configured for the light having undergone the TIR at the first TIR surface to exit the relay optical lens element, wherein the relay optical lens component is configured for the light having undergone TIR at the first TIR surface to propagate directly from the first TIR surface to the second convex lens; the vehicle headlight further includes a DMD (e.g., the DMD 816) configured to receive light exiting the relay optical lens element; and a projection lens (e.g., the projection lens assembly 818) configured to receive light from the digital micromirror device.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1-21. (canceled)

22. An optical projection system comprising:
a light source;
collimating optics configured to provide collimated light from the light source;
a relay optical lens element configured to receive the collimated light, the relay optical lens element comprising:
a relay optical lens component made from a plastic material, the relay optical lens component comprising:
a first convex lens formed of the plastic material, the first convex lens configured to act as an entrance pupil for the relay optical lens element;
a first total internal reflection (TIR) surface formed at a first planar exterior surface of the relay optical lens component, the first TIR surface configured for light having entered through the first convex lens to undergo TIR inside the relay optical lens component at the first TIR surface; and
a second convex lens formed of the plastic material, the second convex lens configured for the light having undergone the TIR at the first TIR surface to exit the relay optical lens element;
a microdisplay configured to receive light exiting the relay optical lens element; and
a projection lens configured to receive light from the microdisplay.

23. The optical projection system of claim 22, wherein the first convex lens is a first aspherical convex lens.

24. The optical projection system of claim 23, wherein the second convex lens is a second aspherical convex lens.

25. The optical projection system of claim 22, wherein the relay optical lens component is configured for the light entering through the first convex lens to propagate directly from the first convex lens to the first TIR surface, the relay optical lens component further comprising:
a second TIR surface formed at a second planar exterior surface of the relay optical lens component, the second TIR surface configured for the light having undergone TIR at the first TIR surface to also undergo TIR at the second TIR surface.

26. The optical projection system of claim 25, wherein the second planar exterior surface abuts the first planar exterior surface.

27. The optical projection system of claim 25, the relay optical lens component further comprising:
a third TIR surface formed at a third planar exterior surface of the relay optical lens component, the third TIR surface configured for the light having undergone TIR at the second TIR surface to also undergo TIR at the third TIR surface.

28. The optical projection system of claim 27, wherein the third planar exterior surface abuts the second planar exterior surface.

29. The optical projection system of claim 22, wherein the relay optical lens element is telecentric.

30. The optical projection system of claim 22, wherein the light source includes multiple light-emitting diodes (LEDs), the optical projection system further comprising:
a microprism on the first planar exterior surface, the microprism configured to extract light generated by the multiple LEDs;
a photosensor configured generate an output based on the light extracted by the microprism; and
a LED driver circuit configured to control the multiple LEDs using the output of the photosensor.

31. The optical projection system of claim 30, wherein the microprism is formed of the plastic material.

32. The optical projection system of claim 30, wherein the microprism is a tetrahedron.

33. The optical projection system of claim 22, further comprising a first antireflection coating on the first convex lens.

34. The optical projection system of claim 33, further comprising a second antireflection coating on the second convex lens.

35. The optical projection system of claim 22, further comprising a mounting feature for mounting the relay optical lens element, the mounting feature positioned on the relay optical lens component.

36. The optical projection system of claim 35, wherein the mounting feature is formed from the plastic material.

37. The optical projection system of claim 22, further comprising a datum feature that is a reference for the relay optical lens element, the datum feature positioned on the relay optical lens component.

38. The optical projection system of claim 37, wherein the datum feature is formed from the plastic material.

39. The optical projection system of claim 22, further comprising a microlens array positioned between the collimating optics and the relay optical lens element.

40. The optical projection system of claim 22, wherein the microdisplay is a liquid crystal on silicon display.

41. (canceled)

42. (canceled)

43. The optical projection system of claim 22, wherein the optical projection system is included in a head-up display system for a vehicle.

44. (canceled)

45. (canceled)
